(19) United States
(12) Patent Application Publication
(10) Pub. No.: US 2019/0285505 A1
(43) Pub. Date: Sep. 19, 2019

(54) Water Leak Test System and Method

(71) Applicant: Dennis T. Farkas, Aiken, SC (US)

(72) Inventor: Dennis T. Farkas, Aiken, SC (US)

(21) Appl. No.: 16/277,234

(22) Filed: Feb. 15, 2019

Related U.S. Application Data
(60) Provisional application No. 62/642,263, filed on Mar. 13, 2018.

(51) Int. Cl. G01M 3/28; G01F 23/02

(52) U.S. Cl. CPC G01M 3/2807; F16L 21/06; G01F 23/02

(57) ABSTRACT

A system for testing a plumbing system for leaks includes a transparent cylinder at the top of a standpipe and in fluid communication with the interior of the standpipe so that when the standpipe and transparent cylinder are filled with water, and the water level subsequently drops, a leak in the plumbing system is indicated. The transparent cylinder is joined to the standpipe by a flexible, rubberized coupler that adheres to, or is clamped to, the standpipe and cylinder. The system avoids the need for a ladder provided the fill pipe is formed with a curved upper end so it can be hung on the wall of the transparent cylinder when the standpipe is filling with water.

### TECHNOLOGICAL FIELD

This disclosure relates to water leak testing and, in particular, testing of plumbing systems for sewers during construction of a building.

### BACKGROUND

In constructing a home, apartment building, office building or other type of building that has a sewer distribution system, the piping comprising that system is checked for leaks. The following particular testing process is required in building codes. A ten-foot standpipe is connected to the plumbing system and filled with water. The height of the 10-foot column of water in the standpipe applies a pressure of approximately 5 psi throughout the system. The level of the water in the standpipe is checked after a period of time, such an hour, to see if the level of water is lower. A drop in level indicates a leak in the plumbing system.

The test itself is satisfactory but the conditions under which it is performed are often challenging. A ten-foot vertical standpipe requires the person who fills the standpipe and checks it to have a ladder. Construction sites, particularly near water pipes in shallow open ditches, are not always smooth, level, and firm, and thus rarely provide a proper surface for a ladder. The ladder available should be a stepladder, which provides its own support rather than a straight ladder that requires a convenient close-by structure against which it can be leaned. The stepladder should also be tall enough so that someone standing near the top of it can see into the top of the 10-foot standpipe and monitor the filling of the standpipe without having to stand on the topmost step.

### SUMMARY

The present system and method include at least three components. The first component is a fill pipe in the shape of the letter J, that is, with a 180° curve in the distal end so that it may be hung on the top of the wall of the standpipe with its open end inside the standpipe to fill the standpipe with water. The proximal end of the fill pipe has a threaded fitting so that a water hose may be securely attached, and a simple shutoff valve. The fill pipe avoids the need for a ladder for filling the standpipe with water.

The second component of the present system is a transparent cylinder. The transparent cylinder is attachable to the top of the standpipe. The transparent cylinder enables user to see the height of the column of water inside of it. When the transparent cylinder replaces the top portion of the standpipe, and the standpipe and transparent cylinder are filled with water, then the water level can be seen through the transparent cylinder by a worker standing on the ground nearby. The transparent cylinder may be marked with gradations so that a worker or inspector standing on the ground can track the changing water level easily even if it changes slowly.

The third component is a flexible coupling that secures the first end of the transparent cylinder to the top of the standpipe and seals the joint between them. The flexible coupling may be a tube-shaped rubberized fabric glued to the transparent cylinder or held by two hose clamps to the top of the standpipe below the joint and the first end of the transparent cylinder above the joint tightly enough so the joint does not leak. Any suitable clamp may be used. Hose clamps are conveniently available in a variety of sizes and easy to use.

A standpipe that is shorter than 10 feet (300 cm) is an optional fourth component in the present system. Polyvinyl chloride (PVC) piping may come in standard 10-foot (300 cm) lengths and, as the test requires a 10-foot column of water and the transparent cylinder is attached to the top of the standpipe, a portion of a standard 10-foot PVC pipe must be removed. It may be convenient to prepare the standpipe and attach the transparent cylinder in advance of need.

In use, the cylinder is connected to the standpipe using the flexible coupling. The flexible coupling secures the first end of the transparent cylinder to the top of the standpipe in a water-tight manner. The proximal end of fill pipe is threaded to a water hose and then raised so that its curve at its top end hangs over the wall of the transparent cylinder. The shutoff valve of the fill pipe is opened to begin filling the standpipe and at least a portion of the transparent cylinder with water. The water level will be apparent as the water begins to fill the transparent cylinder. The water flow is stopped by closing the shutoff valve when the level of water can be seen though the wall of the transparent cylinder. The fill pipe is then lifted clear of the wall of the transparent cylinder and lowered. The level of water and time are noted. After a period of time, such as an hour, the level of water is again noted. If the water level has not dropped, there are no leaks. The testing requires no ladder.

Those skilled in the art of sewer system leak testing will appreciate the many features and advantages of the present system from a careful reading of the Detailed Description accompanied by the following drawings.

### BRIEF DESCRIPTION OF THE DRAWINGS

In the figures,

FIG. 1 shows a portion of a construction site with a standpipe attached to a sewer line with the present water leak test system, according to an aspect of the disclosure;

FIG. 2 shows a fill pipe with attached water hose, according to an aspect of the disclosure; and

FIG. 3 shows a transparent cylinder attached to a standpipe, according to an aspect of the disclosure.

### DETAILED DESCRIPTION

Disclosed herein a system for testing plumbing connections for water leaks. The present system may be used by a plumbing contractor or an inspector at a job site. When sewer lines are established or prior to building the foundation or pouring basement flooring, the plumbing can be tested.

As used herein, the word transparent will be used to include completely transparent materials and also those that are “water-level apparent,” i.e., through which the level of water on an opposing side of the material can be seen. Therefore, in daylight, a somewhat translucent parent material may be water-level apparent and fall within the specific definition of transparent used herein.

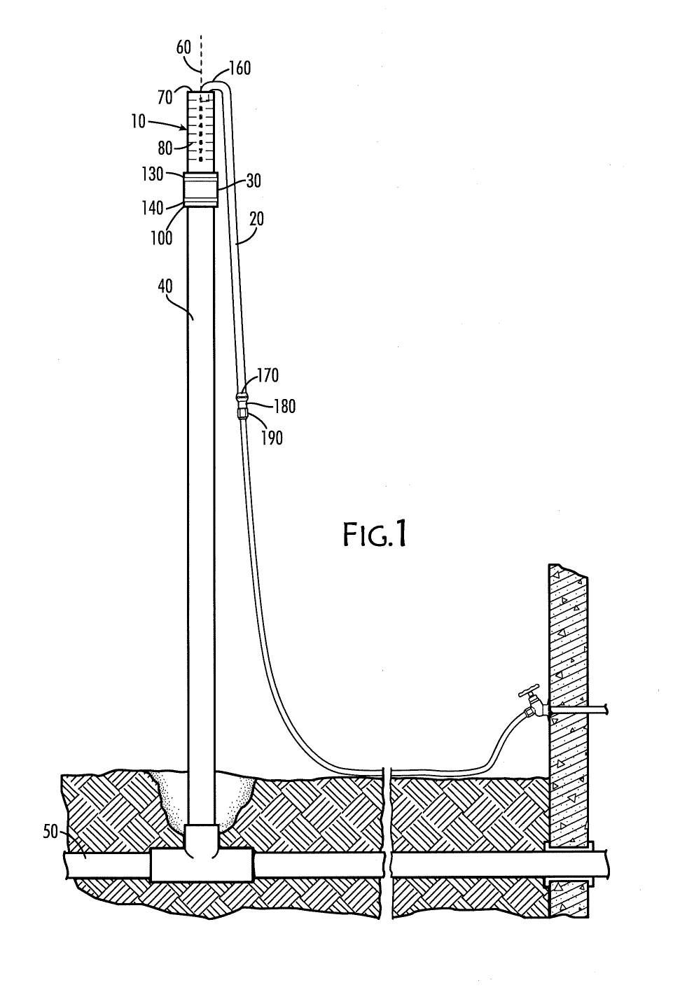

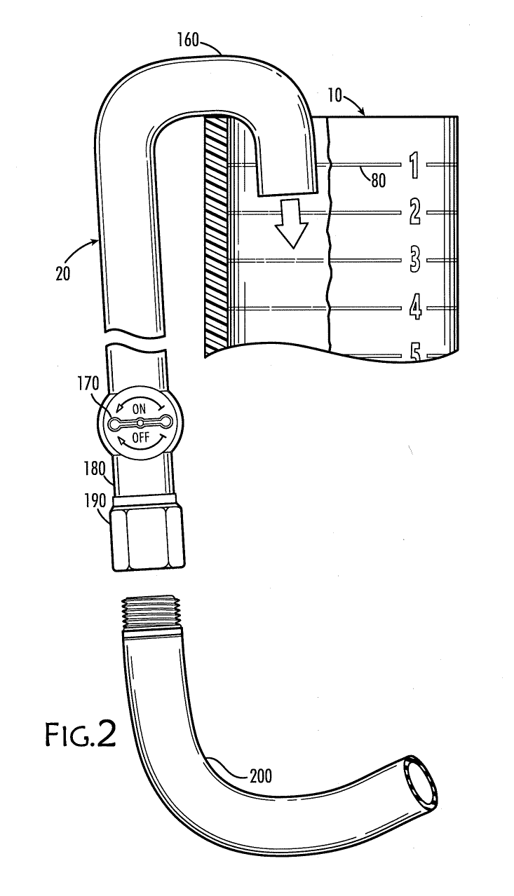

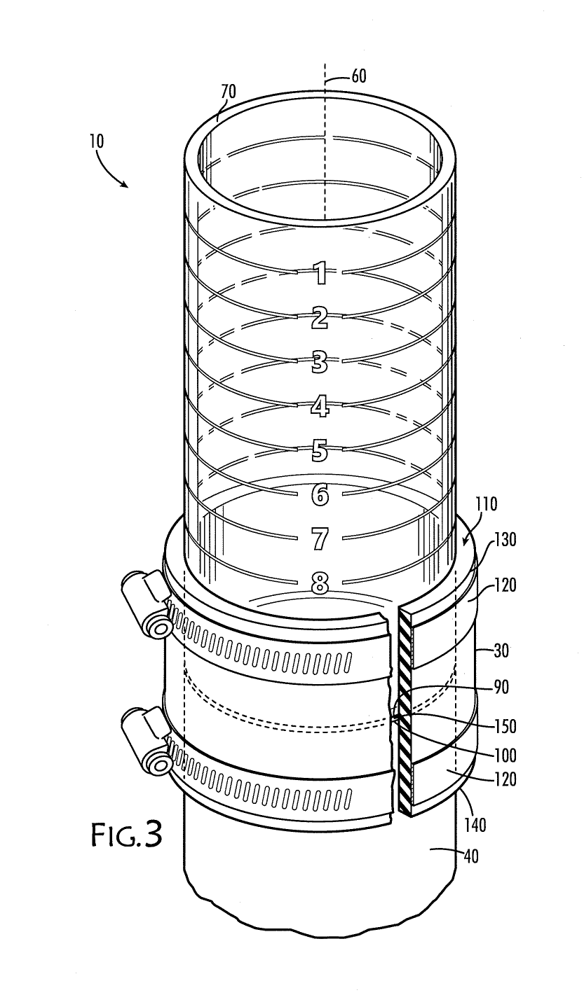

Referring now to FIGS. 1, 2, and 3, the system includes a transparent cylinder 10, a fill pipe 20 and a flexible coupling 30. It may also include a standpipe 40 or the present system may be used with standpipe 40 provided with transparent cylinder 10, fill pipe 20 and flexible coupling 30 or may be available at the job site and therefore not be included with the system. The components of the system may be provided as a kit.

Standpipe 40 is a vertical pipe having a vertical axis when attached to a plumbing system 50. Standpipe 40 is sealed either permanently or temporarily to plumbing system 50 and is intended to be filled with a fluid, such as water. When filled with water, the pressure of the water in a ten-foot tall (approximately 300 cm) standpipe 40 is sufficient to test for leaks under current US plumbing code. If the level of water in the standpipe 40 drops thereafter, there is a leak.

As part of the present system, standpipe 40 is somewhat shorter, such as up to one foot or 30 cm shorter. If there is a 300 cm standpipe 40 at the job site, the top portion—20 cm or so, for example—is cut off.

Transparent cylinder 10 may be completely transparent and is made of a material that is durable and generally scratch-resistant so that it can be used repeatedly at job sites. Transparent cylinder 10 may be made of a clear acrylic polymer, for example. Transparent cylinder 10 may be the same diameter as standpipe 40 and, if standpipe 40 is included in the present system, is the same diameter as transparent cylinder 10, such as 7-8 cm, and has an axis 60. Along a wall 70 of transparent cylinder 10 in a direction parallel to axis 60 is an evenly-spaced series of marks 80.

Marks 80 are evenly-spaced, that is, spaced a pre-determined fixed distance apart, in order to facilitate determination of a change in water level in transparent cylinder 10 by someone standing on the ground and looking at transparent cylinder 10. Regular marks 80 may be made, for example, in one-inch (2.5 cm) increments—for example, four increments—which may be numbered, and are sized to be visible when the present system is in its intended use.

A first end 90 of transparent cylinder 10 is coupled coaxially to the top 100 of standpipe 40 using, for example, a flexible coupler 110 and two hose clamps 120 or an adhesive between flexible coupler 110 and standpipe 40. Flexible coupler has a first end 130 and a second end 140. A hose clamp 120 fastens first end 130 of flexible coupler 110 to transparent cylinder 10 above a joint 150 formed when first end 90 of transparent cylinder 10 is placed against top 100 of standpipe 40. The second hose clamp 120 fastens second end 140 of flexible coupler 110 below joint 150.

A fill pipe 20 is a section of pipe with a curved end 160 so that it somewhat resembles a cane. Opposing curved end 160 of fill pipe 20 is a bottom 180 that has a fitting 190 connectable to a water hose 200. Curved end 160 is curved to enable someone standing on the ground to hang curved end 160 of fill pipe 20 onto the wall 70 of transparent cylinder 10, to observe the water level in transparent cylinder 10 and easily remove fill pipe 20 without having to hold it in place and without requiring a ladder to hang fill pipe 20, to observe the water level in transparent cylinder 10, or to remove it.

Fill pipe 20 may also include a shutoff valve 170 so that the user can open the shutoff valve 170 to begin to fill standpipe 40 and transparent cylinder 10 with water through fill pipe 20 and to close shutoff valve 170 when standpipe 40 and transparent cylinder 10 are sufficiently full. Shutoff valve 170 may be located closer to bottom 180 of fill pipe 20 for convenience of the user. Fill pipe 20 is also long enough so that the user, standing on the ground and holding fill pipe 20, can operate shutoff valve 170 and can place curved end 160 of fill pipe 20 on wall 70. Fill pipe 20 may be 150 cm long.

In use, standpipe 40 is attached to plumbing system 50. Transparent cylinder 10 is attached to standpipe 40. These steps may be done in either order. If standpipe 40 is more than 9 feet (about 270 cm) tall, a portion of it, for example, 20 cm, may be removed to make the total of standpipe 40 and transparent cylinder 10 approximately 300 cm tall.

The first end 90 of transparent cylinder 10 is attached to top 100 of standpipe 40 using a flexible coupler 110 and two hose clamps 120, one tightening flexible coupler 130 to transparent cylinder 10 above joint 150 and another tightening flexible coupler 130 to standpipe 40 below joint 150.

Fill pipe 20, with shutoff valve 170 closed, is raised so that curved end 160 can be hung from wall 70 of transparent cylinder 10. Shutoff valve 170 is opened to thereby fill standpipe 40 and at least a portion of transparent cylinder 10 with water. Shutoff valve 170 is closed and fill pipe 20 is removed from wall 70.

The level of water in transparent cylinder 10 is noted by its proximity to the nearest mark 80. After a period of time, the level of water is observed again to see if it has changed. A decrease in water lever implicates a leak in plumbing system 50.

Those skilled in testing plumbing systems for leaks will appreciate that many changes and substitutions may be made in the foregoing description without departing from the spirit and scope of the overall disclosure, which is captured in the appended claims.

What is claimed is:

1. A system for use in plumbing construction, said system comprising:
(a) a standpipe having a first axis and a top end;
(b) a transparent cylinder having first end and a second axis, said transparent cylinder being incrementally marked parallel to said second axis; and
(c) a coupling, said coupling holding said top end of said standpipe to said first end of said transparent cylinder so said standpipe and said transparent cylinder are co-axial.

2. The system of claim 1, further comprising a fill pipe having a first end with a hose fitting and an opposing, second end that is curved, said fill pipe being shaped and dimensioned to fill said standpipe and said transparent cylinder from below said first end of said standpipe.

3. The system of claim 2, wherein said fill pipe has a shutoff valve.

4. The system of claim 1, wherein said transparent cylinder is a pipe.

5. The system of claim 1, wherein said transparent cylinder is made of acrylic polymer.

6. The system of claim 1, wherein said coupling is a flexible coupling.

7. The system of claim 1, wherein said coupling is attached to said transparent cylinder and said standpipe using adhesive.

8. A kit for use in plumbing construction including a standpipe, comprising:
(a) a transparent cylinder;
(b) a flexible coupler; and
(c) a fill pipe, wherein said transparent cylinder has an axis and incremental marks along said transparent cylinder perpendicular to said axis, and wherein said flexible coupler is operative to couple said transparent cylinder to said standpipe of said plumbing system, and wherein said fill pipe has a curved end operable to fill said transparent cylinder when said transparent cylinder is coupled by said flexible coupler to said standpipe.

9. A method for testing plumbing construction, said method comprising the steps of:
(a) attaching a standpipe to plumbing construction, said standpipe having a top;
(b) attaching a transparent cylinder to said top of said standpipe;
(c) then adding water said standpipe and said transparent cylinder; and then
(d) observing a level of said water in said transparent cylinder over a period of time to see whether the level of water in said transparent cylinder declines.

10. The method of claim 9, wherein said standpipe and said transparent cylinder are approximately 300 cm and wherein said method further comprises the steps of:
(a) hanging a curved end of a fill pipe on said transparent cylinder; and
(b) filling said standpipe and at least a portion of said transparent cylinder with water from said fill pipe.

11. The method of claim 9, wherein said standpipe has a top and said transparent cylinder has a first end, and wherein said method further comprises the steps of
(a) providing a flexible coupler having a first end and a second end;
(b) attaching a first end of said flexible coupler to said transparent cylinder; and
(c) attaching a second end of said flexible coupler said to said standpipe.

12. The method of claim 11, further comprising the step of using adhesives for attaching said flexible coupling to said transparent cylinder and said standpipe.
